(19) United States
(12) Patent Application Publication
(10) Pub. No.: US 2020/0263879 A1
(43) Pub. Date: Aug. 20, 2020

(54) AN OVEN COMPRISING A WATER TANK

(71) Applicant: ARCELIK ANONIM SIRKETI, Istanbul (TR)

(72) Inventors: Ilhan OFLUGIL, Istanbul (TR); Yalcin YAMAN, Istanbul (TR); Oguz TAN, Istanbul (TR); Turgut YERLIKAYA, Istanbul (TR); Mehmet Murat MAMATOGLU, Istanbul (TR)

(21) Appl. No.: 16/066,054

(22) PCT Filed: Nov. 17, 2016
(86) PCT No.: PCT/TR2016/050450

§ 371 Date: Jun. 25, 2018

(30) Foreign Application Priority Data
Dec. 29, 2015 (TR) 2015/17362

(51) Int. Cl. F24C 15/32; A21B 3/04; A47J 27/04

(52) U.S. Cl. CPC F24C 15/327; A47J 2027/043; A47J 27/04; A21B 3/04

(57) ABSTRACT

The present invention relates to an oven, comprising a cooking chamber wherein the ingredients to be cooked are placed; a casing in the form of a box with the front side open; a door that provides access to the cooking chamber; a steam generator that is disposed on the casing, and a water tank that is disposed on the casing and that enables water to be delivered to the steam generator by means of a water delivery line.

The present invention relates to an oven comprising a water tank.

In ovens, the cooking process is generally performed by operating together the heaters and the fan disposed in the cooking chamber. The hot air heated by the heaters disposed on the ceiling, the base or the rear wall of the cooking chamber is distributed into the cooking chamber by means of the fan. In cooking devices that have the steam cooking function, the steam cooking is performed by delivering the steam obtained from the water heated in the steam generator to the cooking chamber. However, the placing of the water tank that enables water to be delivered to the steam generator and the filling of the water tank by the user create a difficulty.

In the state of the art European Patent Application No. EP1909038, a cooking device is disclosed, comprising a steam generator.

The aim of the present invention is the realization of an oven comprising a water tank of which the ease of assembly is facilitated.

The oven realized in order to attain the aim of the present invention, explicated in the first claim and the respective claims thereof, comprises a cooking chamber wherein the ingredients to be cooked are placed; a casing in the form of a box with the front side open; a door that provides access to the cooking chamber; a steam generator that is disposed on the casing, and a water tank that is disposed on the casing and that enables water to be delivered to the steam generator by means of a water delivery line.

The oven of the present invention comprises
a first opening that is disposed at the front wall of the casing, and
a filling orifice that is disposed on the water tank, and that has an open position wherein the filling orifice is taken out by passing through the first opening and enables the water to be filled into the water tank, and a closed position that the filling orifice is brought to by being moved from the open position and wherein the filling orifice is placed into the water tank.

The filling orifice is placed into the water tank, thus the need for forming a connection between the filling orifice and the water tank is eliminated. Moreover, the filling orifice and the water tank forms a compact structure that occupies less space in the oven by being grouped together.

In an embodiment of the present invention, the oven comprises a hinge that enables the filling orifice to be attached on the water tank so as to rotate around the axis to which the filling orifice is connected. The filling orifice is connected to the hinge from one edge and is pulled out of the water tank by being pulled from the edge that is away from the hinge. The filling orifice can be opened by being pulled to the right or to the left according to the position of the hinge.

In another embodiment of the present invention, the hinge enables the filling orifice to automatically move to the closed position from the open position by means of the door contacting the filling orifice during the closing of the door. In this embodiment, the orifice is connected to the hinge from the edge that is close to the edge where the door is connected to the casing, thus the door and the filling orifice are opened in the same direction. The door bears against the filling orifice while being closed, and pushes the filling orifice towards the interior of the water tank so as to bring the filling orifice to the closed position. Thus, in case the user forgets the filling orifice in the open position and closes the door, the filling orifice moves to the closed position by being pushed by means of the door. The filling orifice is enabled to move with the door, and the filling orifice is prevented from applying force to the door. Thus, the door is prevented from damaging the filling orifice by hitting.

In another embodiment of the present invention, the water tank comprises a level sensor. The level sensor enables the amount of the water in the water tank to be detected by means of a buoy placed into the water tank.

In another embodiment of the present invention, the oven (1) comprises
a second opening that is disposed at the front wall of the casing, and
a level indicator that is disposed on the water tank, that is seated into the second opening when the water tank is placed to the casing and that enables the data taken from the level sensor to be delivered to the user. By the water level indicator being placed to the front wall of the casing, the user is enabled to control the water level in the water tank while adding water to the filling orifice. Thus, overflowing from the water tank to the interior of the oven is prevented.

In another embodiment of the present invention, the filling orifice comprises at least one handle. Thus, a holding zone is formed for the user to pull the filling orifice forward while taking out the filling orifice in the water tank. The handle is wide enough for the user to place his/her fingers. Moreover, the handle has a shape whereon the user can easily place his/her fingertips. Thus, the user is enabled to grasp the filling orifice better and user satisfaction is increased.

In an embodiment of the present invention, the oven comprises a valve that is disposed on the water delivery line. By means of the valve, the amount of the water delivered to the steam generator from the water tank is controlled.

By means of the present invention, hose connections are decreased by the filling orifice, the level sensor and the level indicator being disposed in the water tank, and ease of assembly and cost advantage are provided.

The oven realized in order to attain the aim of the present invention is illustrated in the attached figures, where:

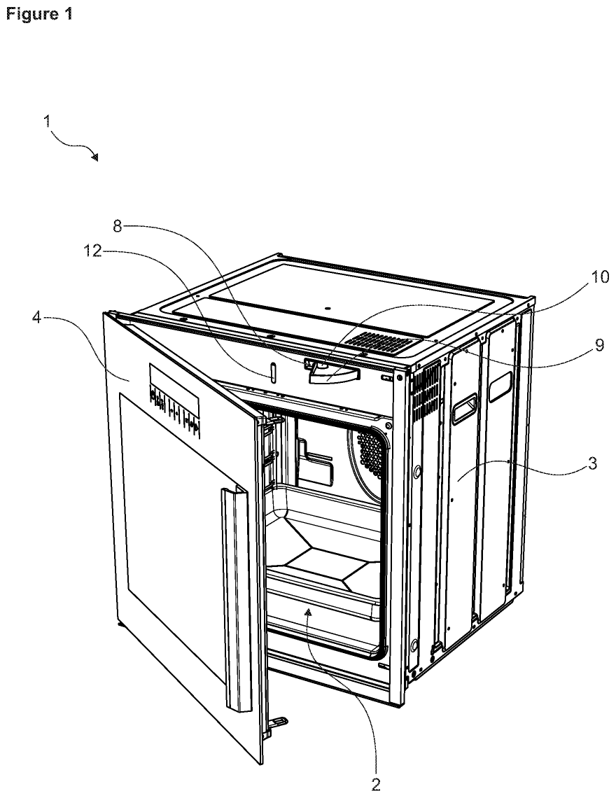

FIG. 1—is the perspective view of an oven.

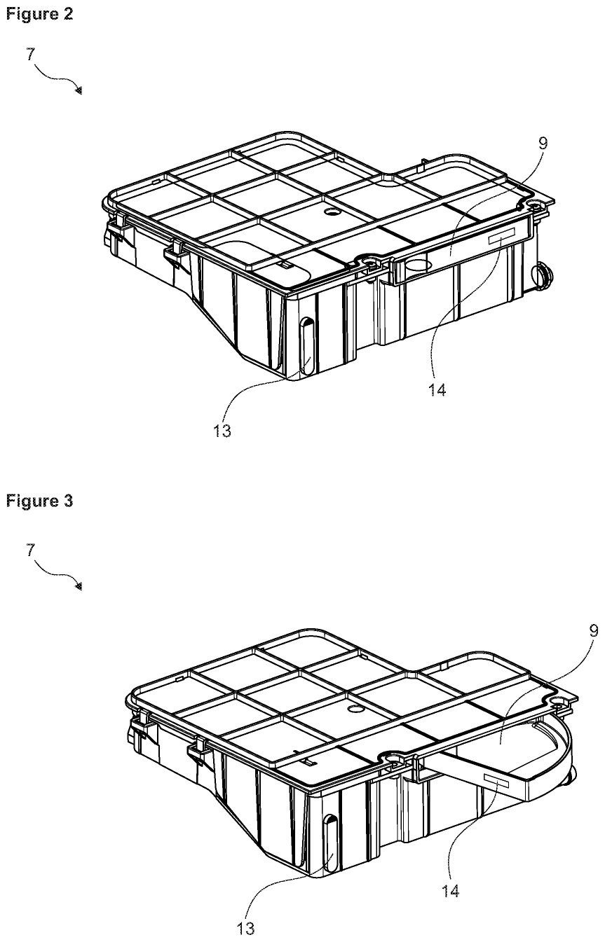

FIG. 2—is the perspective view of the water tank when the filling orifice is in the closed position in an embodiment of the present invention.

FIG. 3—is the perspective view of the water tank when the filling orifice is in the open position in another embodiment of the present invention.

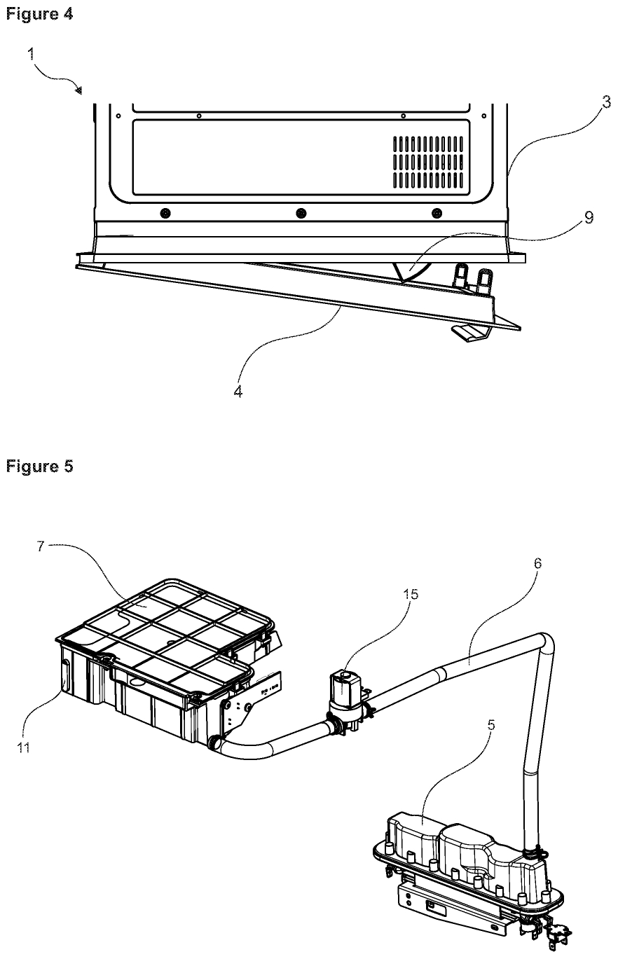

FIG. 4—is the top view of the oven in another embodiment of the present invention.

FIG. 5—is the perspective view of the water tank and the steam generator in another embodiment of the present invention.

The elements illustrated in the figures are numbered as follows:
1. Oven
2. Cooking Chamber
3. Casing
4. Door
5. Steam generator
6. Water delivery line
7. Water tank
8. First opening
9. Filling orifice
10. Hinge
11. Level sensor
12. Second opening
13. Level indicator
14. Handle
15. Valve

The oven (1) comprises a cooking chamber (2) wherein the ingredients to be cooked are placed; a casing (3) in the form of a box with the front side open; a door (4) that provides access to the cooking chamber (2); a steam generator (5) that is disposed on the casing (3); and a water tank (7) that is disposed on the casing (3) and that enables water to be delivered to the steam generator (5) by means of a water delivery line (6) (FIG. 1 and FIG. 2).

The oven (1) of the present invention comprises
a first opening (8) that is disposed at the front wall of the casing (3), and
a filling orifice (9) that is disposed on the water tank (7), and that has an open position wherein the filling orifice (9) is taken out by passing through the first opening (8) and enables the water to be filled into the water tank (7), and a closed position that the filling orifice (9) is brought to by being moved from the open position and wherein the filling orifice (9) is placed into the water tank (7).

The first opening (8) is positioned at the front wall of the casing (3) so as to remain behind the door (4) when the door (4) is closed. The filling orifice (9) is positioned in the water tank (7), and the user can bring the filling orifice (9) to the open position by taking out the filling orifice (9) from the water tank (7) in order to fill water to the water tank (7). The user places the filling orifice (9) to the water tank (7) by pushing and bringing the filling orifice (9) back to the closed position after filling water into the water tank (7) by means of the filling orifice (9). The filling orifice (9) becomes coplanar with the casing (3) when in the closed position, thus prevents the door (4) from being closed (FIG. 1).

In an embodiment of the present invention, the oven (1) comprises a hinge (10) that enables the filling orifice (9) to be attached on the water tank (7) so as to rotate around the axis the filling orifice (9) is connected to. The filling orifice (9) is brought to the open position from the closed position and to the closed position from the open position by being rotated around the hinge (10). The user enables the filling orifice (9) to be taken out of the water tank (7) by pulling out the filling orifice (9) after opening the door (4).

In another embodiment of the present invention, the hinge (10) enables the filling orifice (9) to automatically move to the closed position from the open position by means of the door (4) contacting the filling orifice (9) during the closing of the door (4). In this embodiment, the filling orifice (9) is moved to the open position from the closed position to the closed position from the open position by being rotated in the same axis with the door (4). When the door (4) is closed when the filling orifice (9) is in the open position, the surface of the door (4) that faces the cooking chamber (2) bears against the filling orifice (9). After the door (4) contacts the filling orifice (9), the filling orifice (9) is forced by the pushing force applied by the user so as to switch to the closed position by being rotated around the hinge (10). Thus, as the door (4) is being closed, the filling orifice (9) is rotated around the hinge (10) by means of the door (4) and is brought to the closed position. Thus, when the oven (1) is operated, the filling orifice (9) is prevented from being forgotten in the open position. Moreover, by the filling orifice (9) being rotated together with the door (4), the filling orifice (9) is prevented from being broken by hitting the door (4) in case the door (4) is closed when the filling orifice (9) is in the open position.

In another embodiment of the present invention, the water tank (7) comprises a level sensor (11). The level sensor (11) enables the amount of the water in the water tank (7) to be detected by means of a buoy placed into the water tank (7).

In another embodiment of the present invention, the oven (1) comprises
a second opening (12) that is disposed at the front wall of the casing (3), and
a level indicator (13) that is disposed on the water tank (7), that is seated into the second opening (12) when the water tank (7) is placed to the casing (3) and that enables the data taken from the level sensor (11) to be delivered to the user. The water level detected by the level sensor (10) is delivered to the user by means of the level indicator (13). By the level indicator (13) being placed to the water tank (7), the need for the level indicator (13) to be connected to the water tank (7) with a hose is eliminated, thus the change in the water level can be momentarily followed from the level indicator (13). Moreover, by the level indicator (13) being placed to the front wall of the casing (3), the user is enabled to be easily control the water level.

In another embodiment of the present invention, the filling orifice (9) comprises at least one handle (14). The user can take out the filling orifice (9) from the water tank (7) by grasping the handle (14). Thus, the user is enabled to grasp the filling orifice (9) better and user satisfaction is increased.

In an embodiment of the present invention, the oven (1) comprises a valve (15) that is disposed on the water delivery line (6). By means of the valve (15), the amount of the water delivered to the steam generator (5) from the water tank (7) is controlled. By the valve (15) being opened before the steam generator (5) is operated, the water is carried to the steam generator (5) from the water tank (7). Thus, the steam generator (5) is prevented from being burned as a result of the steam generator (5) being operated without water.

In the oven (1) of the present invention, the filling orifice (9), the level sensor (11) and the level indicator (13) are grouped by being disposed on the water tank (7), thus providing ease of assembly.

1. An oven, comprising a cooking chamber wherein ingredients to be cooked are placed; a casing in form of a box with a front side open; a door that provides access to the cooking chamber; a steam generator that is disposed on the casing, and a water tank that is disposed on the casing and that enables water to be delivered to the steam generator by means of a water delivery line, characterized by
a first opening that is disposed at a front wall of the casing, and
a filling orifice that is disposed on the water tank, and that has an open position, wherein the filling orifice is taken out by passing through the first opening and enables the water to be filled into the water tank, and a closed position that the filling orifice is brought to by being moved from the open position and wherein the filling orifice is placed into the water tank.

2. The oven as in claim 1, characterized by a hinge that enables the filling orifice to be attached on the water tank so as to rotate around an axis the filling orifice is connected to.

3. The oven as in claim 2, characterized by the hinge that enables the filling orifice to automatically move to the closed position from the open position by means of the door contacting the filling orifice during closing of the door.

4. The oven as in claim 1, characterized by a level sensor that is disposed in the water tank.

5. The oven as in claim 4, characterized by
a second opening that is disposed at the front wall of the casing, and
a level indicator that is disposed on the water tank, that is seated into the second opening when the water tank is placed to the casing and that enables data taken from the level sensor to be delivered to a user.

6. The oven as in claim 1, characterized by at least one handle that is disposed on the filling orifice.

7. The oven as in claim 1, characterized by a valve that is located on the water delivery line.
